(19) United States
(12) Patent Application Publication
(10) Pub. No.: US 2015/0231427 A1
(43) Pub. Date: Aug. 20, 2015

(54) Fire or Smoke Barrier

(71) Applicant: COOPERS FIRE LIMITED, Havant Hampshire (GB)

(72) Inventors: Andrew Paul Coopers, Hampshire (GB); Aaron Lynn Neil Kelly, Hampshire (GB)

(21) Appl. No.: 14/429,048

(22) PCT Filed: Sep. 2, 2013
(86) PCT No.: PCT/GB2013/052289

§ 371 Date: Mar. 18, 2015

(30) Foreign Application Priority Data
Sep. 21, 2012 (GB) 1217043.7

(51) Int. Cl. A62C 2/10; E06B 9/80

(52) U.S. Cl. CPC A62C 2/10; E06B 9/80

(57) ABSTRACT

A fire or smoke barrier has a head box, a drum holding a curtain and a bottom bar for weighing the curtain. A stop mechanism includes a series of stops preventing the bottom bar of the curtain from descending. The stops being connected together, and held in non-deployment position. The barrier also includes a release such that in the event of a fire the stops can be withdrawn from their position by pivoting out of the way of the bottom bar either in the plane parallel to the bottom bar, or by rotation about their end to a position 90° to their original position. The release includes a handle to move the stops, and may include a spring to withdraw the stops. In addition the release includes thermal links which fail on temperature rise to allow a spring to move the stops away from the bottom bar resulting in deployment of the curtain.

The present invention relates to the deployment of a fire or smoke barrier.

The European standard for fire and smoke curtains states that in the event of a power failure, corruption, or activation of the system, the curtain must deploy to its operational position. Such a system in described in my earlier patent GB2320944.

However, in situations where the activation signal is a false alarm, this still results in deployment of the curtain and significant inconvenience, including time and cost to reset the curtain.

The object of the present invention is to provide improved fire or smoke barrier.

According to the invention there is provided a fire or smoke barrier comprising
a head box for housing a curtain, open at its underside to allow the curtain to be deployed and withdrawn;
a drum, housed in the head box, for the curtain to be rolled from for deployment and rolled back onto for withdrawal;
a bottom bar attached to the bottom of the curtain for weighing the curtain;
at least one stop positioned beneath the bottom bar, arranged such that the stop(s) hold up the bottom bar, preventing deployment of the curtain, unless withdrawn by a release means.

The stop mechanism may be used as the main mechanism for deployment of a curtain. On release of the stop(s), the curtain will deploy due to the weight of the bottom bar. When used as such, the arrangement will also include further means for withdrawal of the curtain after deployment, for example after testing. This may be a manual crank means or may be a motorised means.

However, the mechanism may also be used as an addition to a mechanism such as described in my earlier patent GB2320944, incorporating a gravity fail safe mechanism. In this case the mechanism of the invention acts to prevent a false alarm or power failure causing deployment of the curtain and disruption to the building.

Preferably the stop(s) are provided on an underside of the headbox.

The stop(s) can be in the form of a lever arm. Where more than one lever arm is provided, typically they will be connected together by a dowel, to move all lever arms together. The lever arms can be arranged to either pivot about a point on the underside of the head box, such that they pivot in a plane parallel with the underside of the head box. Alternatively the lever arms can be arranged to rotate about their ends to a position 90° to their original position, allowing the bottom bar to descend.

Typically the stop(s) will be connected to a cord, wire or other substantially non-stretchable material, extended between the stop or a dowel connecting a number of stops, and the release means. The stop or dowel can be connected to a spring or other retraction means. Under normal conditions, the cord holds the stop(s) under the bottom bar. However, if released, the spring rotates the stop(s) away from the bottom bar, allowing deployment of the curtain. The release means can be in the form of a handle, such that in one position, the cord is passed over a spindle extending it further, but when released the cord is relaxed, allowing the spring to move the stop(s). Alternatively the release means can be in the form of a pivot, with the cord attached to one end of the pivot, and a pin or other holding means, holding the pivot in an extended position. Release of the pin allow pivoting to relax the cord, allowing the spring to move the stop(s) to allow deployment of the curtain.

In some embodiments the release means will include a mechanical thermal link such that if heat from a fire is detected, the mechanism will activate automatically with no further input from a fire warden, allowing deployment of the curtain.

To help understanding of the invention, a specific embodiment thereof will now be described by way of example and with reference to the accompanying drawings, in which:

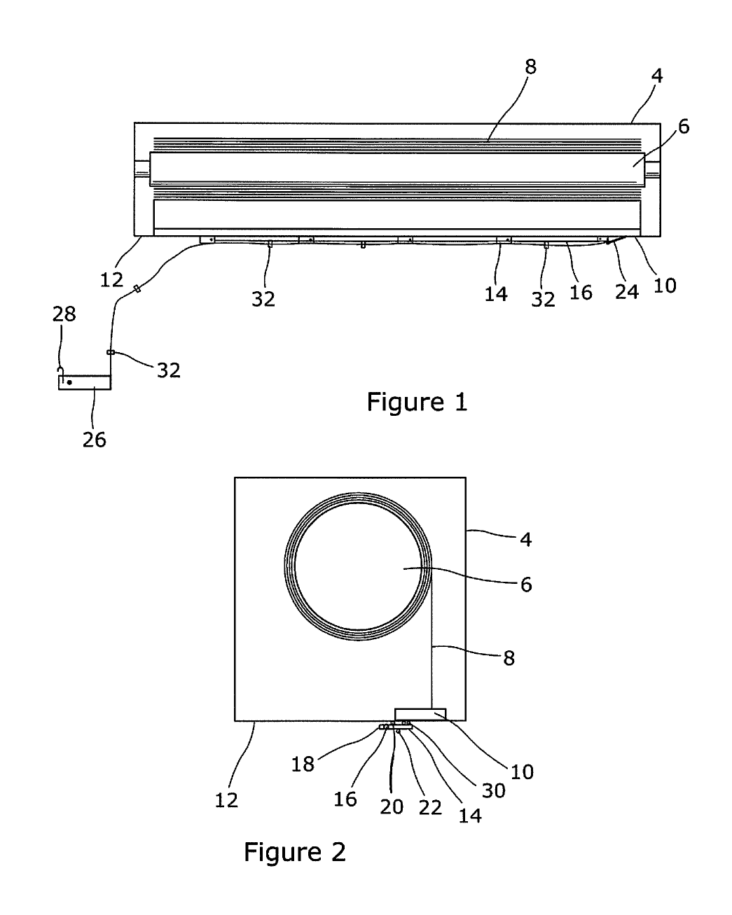

FIG. 1 is a front cross-sectional view of a curtain according to the invention;

FIG. 2 is a side cross-section view of the curtain of FIG. 1;

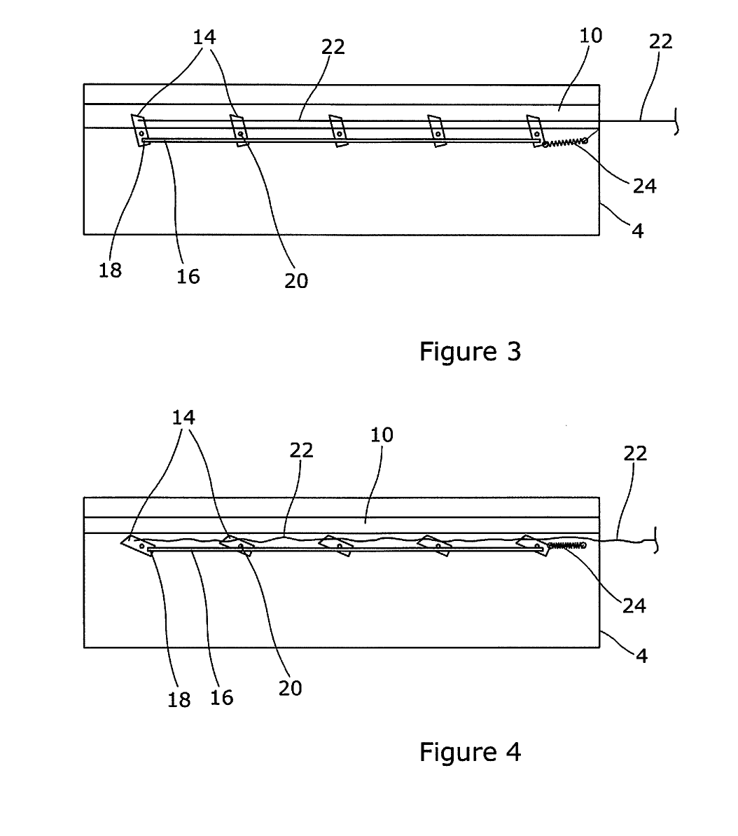

FIG. 3 is a bottom view of the head box of FIG. 1 in normal position; and

FIG. 4 is a bottom view of the head box of FIG. 4 with the lever arms withdrawn

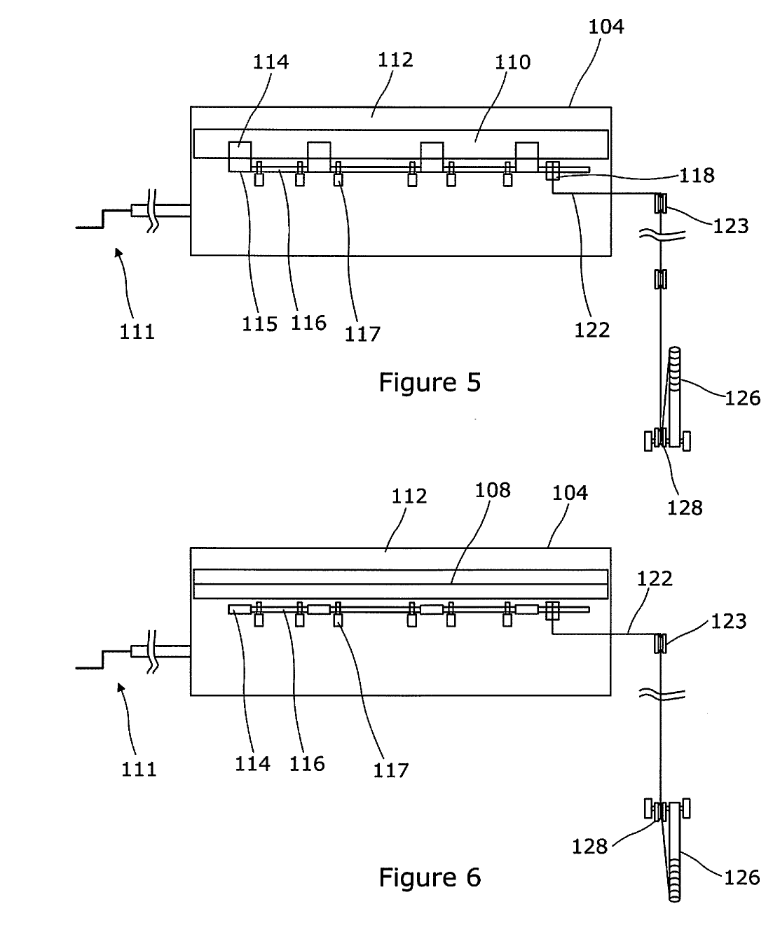

FIG. 5 is a bottom view of the head box according to a second embodiment of the invention; and

FIG. 6 is a bottom view of the head box of FIG. 5 with the lever arms withdrawn.

Referring to the drawings, the fire curtain is provided in a head box 4, in which is supported a drum 6 around which a curtain 8 is rolled. Attached to the bottom of the curtain is a bottom bar 10, which acts as a weight for the curtain, and also to close the head box 4 when the curtain is withdrawn.

The drum 6 includes a motor, gear box, and brake arrangement, which acts to deploy the curtain when necessary, in the event of a fire, or for testing, and to hold the curtain in the withdrawn position when not required. The arrangement is such that on disruption of all power, the brake and the motor are switched off, allowing deployment of the curtain under the weight of the bottom bar 10.

All of this is as generally described in my earlier patent GB 2320944.

In accordance with the present invention, the base 12 of the head box 4 is provided with a series of lever arms 14 connected together with a steel dowel 16.

Each lever arm 14 is pivotally connected to the base on the head box 4, with the dowel 16 connected to points 18 near to one end of the lever arms, to increase moment forces. The lever arms 14 pivot 20 against the head box and are connected together with a wire 22. A spring 24 connects one of the lever arms 14 to the head box. The wire 22 is connected to one end of an arm 26, which is positioned a short distance from the head box, typically on a wall at a convenient height. The pivot arm is held in position by a pin 28.

In normal, non-deployment conditions, the lever arms 14 extend under the bottom bar 10, preventing the deployment thereof under standard activation. The lever arms 14 are provided with ball bearings 30 on their upper sides, on which the bottom bar 10 rests.

Under these conditions, the spring 24 is stretched, and the lever arms are held in this extended position under the bottom bar by the wire 22 and arm 26, and pin 28.

On activation of the fire curtain, the bottom bar 10 will be prevented from descending by the lever arms 14.

However, once it has been determined that the activation is not a false alarm, the pin 28 can be removed, releasing the arm 26, which slackens the wire 22. This allows the spring 24, to withdraw the lever arms 14 away from the bottom bar 10, allowing the same to descend.

In some circumstances, such as where a fire has occurred near to a curtain, it is not convenient for an operator to have to remove pin 28 to allow the curtain to descend. Thermal links 32, made of a material that fails on a small rise in temperature, are positioned along the wire, such that in the event of a fire, these will fail, releasing the wire, and allowing deployment of the curtain.

Referring now to FIGS. 5 and 6, which show a second embodiment of the invention. This embodiment includes a head box 104, including a drum around which a curtain 108 is rolled (not shown). Attached to the bottom of the curtain is a bottom bar 110, which acts as a weight for the curtain and also to close the head box 104, when the curtain is withdrawn.

In contrast to the previous embodiment, the drum does not include a motor, gearbox and brake arrangement, and does not include a gravity fail safe mechanism for activation of the curtain in the event of a total power failure. The arrangement of the invention acts to prevent deployment of the curtain when not required, with the curtain being withdrawn after deployment by means of a crack-shaft and handle 111.

To prevent deployment of the curtain in when not required, the base 112 of the head box 104 is provided with a series of lever arms 114 connected together along their ends 115, to a steel dowel 116. The dowel 116 is connected to the head box 104 by a series of P-clips 117 or pillow blocks, allowing rotation of the dowel. The dowel is also connected to a spindle 118, to control the rotation of the dowel. A wire 122 is connected into the spindle 118, which is fed, typically via a series of pulleys 123, to a release mechanism.

The release mechanism comprises a release handle 126, fixed to a wall, and connected to a spindle 128 around which the wire passes. To hold the lever arms 114 in the up position, holding the bottom bar 110, the release handle 126 is put into the up position, in which the wire 122 is passed around the spindle 128.

As shown in FIG. 6, to release the lever arms 114, the handle in moved to the down position, releasing sufficient of the wire 122 to move the spindle 118 to rotate the dowel 116 and rotate the lever arms 114 downwards and out of the path of the bottom bar 110.

The invention is not intended to be restricted to the details of the above-described embodiment. For instance, thermal links can be incorporated as part of the lever arms, such that in the event of a failure to release the lever arms in any other way, in the event of heat from a fire reaching the lever arms, these fail, allowing deployment of the curtain. Where thermal links in the lever arms are used, it is possible to forgo any other release mechanism, including the spring release mechanism described above.

1. A fire or smoke barrier comprising:
a head box housing a curtain, open at its underside to allow the curtain to be deployed and withdrawn;
a drum, housed in the head box, for the curtain to be rolled from for deployment and rolled back onto for withdrawal;
a bottom bar attached to the bottom of the curtain for weighing the curtain;
at least one stop positioned beneath the bottom bar, arranged such that the stop(s) hold up the bottom bar, preventing deployment of the curtain, unless withdrawn by a release means.

2. A fire or smoke barrier according to claim 1, further including means for withdrawal of the curtain after deployment.

3. A fire or smoke barrier according to claim 2, wherein withdrawal means is a manual crank.

4. A fire or smoke barrier according to claim 1, wherein the stop(s) are lever arms.

5. A fire or smoke barrier according to claim 4, wherein the lever arms are connected together by a dowel to move all lever arms together.

6. A fire or smoke barrier according to claim 4, wherein the lever arms are arranged to pivot about a point on the underside of the headbox, such that they pivot in a plane parallel with the underside of the headbox.

7. A fire or smoke barrier according to claim 4, 5, wherein the lever arms are arranged to rotate about their ends to a position substantially 90° from their original position.

8. A fire or smoke barrier as claimed in claim 1, wherein the release means includes a cord, wire or other substantially non-stretchable material, extending between the stop(s) and the release means

9. A fire or smoke barrier according to claim 8, wherein the release means further includes a spring attached to the cord, wire or other substantially non-stretchable material to withdraw the stop(s).

10. A fire or smoke barrier according to claim 1, wherein the release means further includes a handle, to move the stop(s) to prevent or allow deployment of the curtain.

11. A fire or smoke barrier according to claim 7, wherein the release means includes a handle for pivoting the stop(s) to allow deployment of the curtain.

12. A fire or smoke barrier as claimed in claim 1, wherein the release means includes a thermal link such that heat from a fire will case the thermal link to fail and the means will release, releasing the bottom bar and allowing deployment of the curtain.

13. A fire or smoke barrier according to claim 1, wherein the drum includes a gravity fail safe mechanism.
